(19) United States
(12) Patent Application Publication
(10) Pub. No.: US 2010/0299691 A1
(43) Pub. Date: Nov. 25, 2010

(54) System and Method for Personalization of Television Content Provided by a Set-Top Box Based on a User's Context and Uniquifiers

(75) Inventors: Dotan Emanuel, Herzliya (IL); Sol Tzvi, Herzliya (IL); Tal Elad, Holon (IL)

Correspondence Address: MYERS WOLIN, LLC, 100 HEADQUARTERS PLAZA, North Tower, 6th Floor, MORRISTOWN, NJ, 07960-6834, US

(73) Assignee: GENIEO INNOVATION LTD., Herzliya (IL)

(21) Appl. No.: 12/713,903

(22) Filed: Feb. 26, 2010

Related U.S. Application Data
(60) Provisional application No. 61/213,893, filed on Jul. 27, 2009.
(60) Provisional application No. 61/213,254, filed on May 20, 2009.

(51) Int. Cl. H04N 5/445; G06F 13/00; H04N 7/173

(52) U.S. Cl. 725/14; 725/46; 725/40; 725/110; 725/131

(57) ABSTRACT

A method for personalization of television content comprises determining if input information respective of the television content matches one or more uniquifiers of a user of a set-top box (STB), wherein a uniquifier characterizes a user of a user node that is associated with the STB; updating a personalized content list if the match is determined to exist; and displaying the personalized content list on a television screen coupled to the STB.

### CROSS-REFERENCE TO RELATED APPLICATIONS

This application claims the benefit of U.S. provisional application No. 61/213,893 filed on Jul. 27, 2009 and U.S. provisional application No. 61/213,254 filed on May 20, 2009, the contents of which are herein incorporated by reference.

### TECHNICAL FIELD

The present invention relates generally to personalization of television content, and more specifically to control of content provided to a viewer of a television by its set-top box based on the user's collected characteristics.

### BACKGROUND OF THE INVENTION

Users have today a possibility to reach and be reached by a vast amount of information on a variety of user devices. Such user devices include telephones, hand-held devices, personal computers (PCs), personal digital assistants (PDAs), and the like. The information may be provided to the user in a push mode, that is, information is provided to the user without a specific action on the user's side. In the push mode, information provided in the form of advertisements is most prominent. On the other hand, information may be provided to a user in a pull mode, that is, the user initiates an action that results with providing of information back to the user.

In order for information provided to the user in either a push or pull mode, it is beneficial to characterize the user using some kind of a user profile. This requires monitoring of the user accessing information and attempting to identify patterns that may be then reduced into certain characteristics of the user, usually referred to as a user profile. The created user profile may be then used to better match the information provided to the user based on the user profile. For example, web sites as well as search engines, such as Google®, are known to perform such monitoring by tracking the user either by leaving monitors on the user device or by encouraging the user to log on to the web site, thereby identifying the user. Monitors may be implemented using cookies, which are simple pieces of data that are exchanged between a server and a client, thereby affecting the operation of the web server. Regardless of mode of operation the more information the system attempts to collect about the user the greater the security risk for the user's information, predominantly, the user's privacy. An accurate profile outside of the control of a user may lead to significant privacy breaches that may be detrimental to the user.

Merely collecting information from the user in response, for example, to a questionnaire presented to the user, may be significantly lacking due to inaccuracies and/or the fear of the user from a breach of privacy. Prior art attempts to overcome this drawback by generating clusters of user profiles and fitting a user with other profiles generating a more generic profile of a group of people like the user. However, this may suffer from a significant drawback as this is done typically on per source, for example, a web site, basis, and does not account for the significant variation even within the group.

In typical modern broadcasting video content is delivered to a television set that is coupled to a set-top box. This further enables providing a large number of broadcast channels over a variety of communication links, such as cable, satellite, Internet protocol television (IPTV), and the like. A television content broadcaster provides to the viewers such video content over one or more of the selected networks. The broadcasted content is listed in content (or viewing) lists, e.g., an electronic program guide (EPG) that provide detailed descriptions of the title, content description, timetables, viewing limitations such as ratings, and more. The content list may be displayed on the television and the user may select the content the user wishes to view. The content list is not tailored the user based on, for example, the dynamically changing user needs and viewing habits.

It would be therefore advantageous to provide a solution that generates viewing lists of suggestive viewing content tailored to a profile of a television viewer.

### SUMMARY OF THE INVENTION

Certain embodiments of the invention include a method for personalization of television content. The method comprises determining if input information respective of the television content matches one or more uniquifiers of a user of a set-top box (STB), wherein a uniquifier characterizes a user of a user node that is associated with the STB; updating a personalized content list if the match is determined to exist; and displaying the personalized content list on a television screen coupled to the STB.

Certain embodiments of the invention further include a user node for personalization of television content. The user node comprises an interface to a network, wherein the network is connected to one or more web servers, one or more television content providers, and at least one STB associated with the user node; one or more sensors adapted to collect data respective of the user using the user node; a processing unit for generating a plurality of uniquifiers based on the user usage of the user node and periodically generating a personalized content list for the at least one STB responsive of the plurality of uniquifiers and input information respective of television content; wherein the uniquifiers characterize the user.

Certain embodiments of the invention also include a system for personalization of television content. The system comprises a network; one or more web content servers connected to the network; one or more television content providers connected to the network; one or more user nodes coupled to the network, at least a first user node that generates uniquifiers respective of the user of the first user node and further generates a personalized content list respective of the uniquifiers; and one or more set-top boxes (STBs) coupled to the network, wherein at least a first STB is associated with the first user node, the at least first STB receives the personalized content list

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic block diagram of an architecture of a system in accordance with the principles of the invention;

FIG. 2 is a schematic block diagram of a system implementing the architecture;

FIG. 3 is a flowchart depicting the creation of a user profile in accordance with the principles of the invention;

FIG. 4 is a flowchart depicting the filling of content of a labeled uniquifier (LU);

FIG. 5 is a flowchart depicting the creation of a unlabeled uniquifier (UU);

FIG. 6 is a flowchart depicting the flow from a query to an answer in accordance with the principles of the invention;

FIG. 7 is a schematic diagram of a system for uniquifier based personalized TV in accordance with the principles of the invention; and

FIG. 8 is a flowchart depicting the process of personalization of TV content based on a user's uniquifiers.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments of the invention include identifying and providing to a user, television content tailored to a user based on user's uniquifiers. The determination of suitable content is performed through matching of uniquifiers, while maintaining the user's privacy with respect to the user's uniquifiers. The tailored television content (e.g., programs) can be selected for recording and/or display by automatically programming the set-top box of the user. Furthermore, based on the user's usage pattern of television content, uniquifiers are updated. In another embodiment of the invention, a user tailored programming guide of user's potentially preferred programs is created, based on the user's uniquifiers, and displayed on the screen connected to the set-top box.

An uniquifier is a piece of information that provides unique information about the user. The uniquifiers are of two types: labeled and unlabeled, where labeled uniquifiers have a characterizing label and unlabeled uniquifiers, while providing information about the user, cannot be easily associated with a label. Uniquifiers are further accompanied by a confidence level value and current relevancy level value, indicating the current relevancy of the uniquifiers, which changes over time based on the user activity and context. Both values enable the determination of the strength of the answer provided with respect of the user for a query at a point in time. Global uniquifiers may also be used to compute the strength of each global uniquifier given the current user uniquifiers. Furthermore, as the processing is performed on the user's device, privacy and confidentiality is maintained.

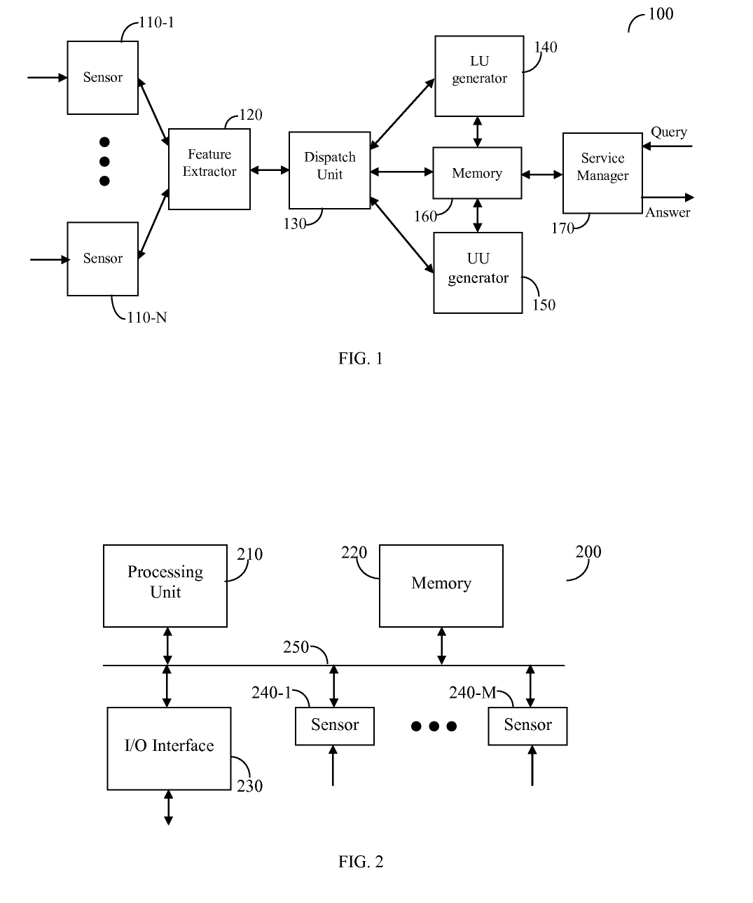

FIG. 1 shows an exemplary and non-limiting schematic block diagram of an architecture 100 of a system that can be constructed in accordance with the principles of the invention. The architecture 100 comprises one or more sensors 110-1 through 110-N (collectively referred to as sensors 110) that are used to collect sensory data about the user as the user uses one of the user devices. A user device may be, but is not limited to, a personal computer (PC), a personal digital assistant, a mobile phone, a smart phone, a set-top box, and the like. In one embodiment of the invention the architecture 100 is embedded into a user device, or attached thereto. The sensors 110 may be sensors for sensing a plurality of environment data such as heat, humidity, sound, light conditions, location, and many other such data that may be obtained through the use of such sensors. Some sensors 110 may be sensors that operate as agents on a system, each agent monitoring one or more aspects of a user's usage of the user device. For example, but without limitation, such sensors may include collection of web pages accesses and/or content thereof, documents prepared, modified or viewed by the user, text typed, capturing of misspelled words, operation times and more. In the disclosed architecture sensors may be added, modified or removed as the need arises and with respect to user behavior when using the user device.

The sensors 110 are connected to a feature extractor 120 which is a unit capable of extracting the features based on the information provided by the sensors 110. The feature extractor 120 may be coupled, for example, to a sensor that provides location information from a global positioning system (GPS), and therefore be able to extract the information of the specific location that a user is in, not the absolute coordinates but the meaning of these coordinates, for example, if the user is at home, at work, or at a shopping mall. Another sensor 110 may provide time information which can then be correlated by the feature extractor 120 to determine if these are work hours or not depending on the time of day, typical behavior of the user, the location of the user, the travel speed and more. The feature extractor 120 may be further enabled to extract information respective of sensed web pages that the user has visited using the user device providing the terms that appear in the web page as well as other usage related information, including, but not limited to, the time spent on that page, scrolling information when applicable, usage of links available on the page, and more.

The feature extractor 120 therefore reduces the amount of sensory data to manageable segments of data that are then called for by a dispatch unit 130 connected to the feature extractor 120. The dispatch unit 130 is responsible of the periodic feeding of other elements of the architecture 100 with data that is then used to develop the uniquifiers. As mentioned above, an uniquifier is a piece of information processed by a generator as will be described herein below, and provides unique information about the user of the user device. The uniquifier is generated responsive of the features extracted by the feature extractor 120 and grouped to provide a specific meaning. An uniquifier may, in some embodiments, be activated or deactivated by a user, thereby changing the user profile. The labeled uniquifiers (LUs) which are uniquifiers that can be tagged with a label that provides a description of the uniquifier. For example, a LU describing the age of the user, has the label “age” while the LU describing the gender of the user has the label “gender”. Other LUs may include, but are not limited to, profession, address or portions thereof, name, height, and so on. In one embodiment of the invention a list of labels may be provided for at least initialization purposes. The labels get associated with respective information (uniquifiers) making them LUs. LUs may also be created as a label if identifiable for an unlabeled uniquifier. It should be appreciated that based on the features extracted by the feature extractor 120 from the data provided by sensors 110, the architecture 100 may provide significant information towards the determination of such user characteristics.

In accordance with an embodiment of the invention a confidence level or levels as to the accuracy of the labeled uniquifier is also provided. For example, in determination of the LU of “age” a plurality of features extracted from a plurality of sensors 110 may be used to associate an age range with a certain confidence level. In another embodiment a second age range may be determined with a lower confidence level which is determined to be over a lesser range. For instance, in the case of the LU “age” an age range may be provided as “18-25” with a confidence level of 95%, and an age range of “20-22” at a confidence level of 85%, The advantage over asking the age from the user is that the user may not provide the correct information for whatever reason, while an analysis of more parameters may lead to a determination that is more accurate. Assessed may be the web sites accessed, the speed of typing, the words used, the location present, and so on, to determine various characteristics of the user. The more sensory data collected the more likely it is that an accurate LU be generated. In accordance with another embodiment of the invention in addition to a confidence level a range of values may be provided.

It should be noted that each LU is generated uniquely and requires special handling by the LU generator 140. For example, the generation of the information associated with the label “age” is orthogonal to the label “gender” that requires a different approach for extraction of its associated information. LUs are stored in memory 160 for further use. It should be noted that LUs are static by nature, or have a very slow and generally predictable change. For example, the LU “age” changes gradually and predictably.

However, not all uniquifiers can have a label and they are referred to herein as unlabeled uniquifiers (UUs) generated by UU generator 150. UUs may be represented in a variety of forms, for example, without limitation, using a vector space model, graphs, and the likes. In one embodiment of the invention the strength of the UU is periodically evaluated. Furthermore, UUs may be periodically generated and updated. Specifically, a similarity between one or more objects (part of a query) and one or more UUs may take place periodically. Objects may include keywords, text, images and the likes. In one embodiment of the invention a threshold value is used for the determination of a similarity or for the purpose of delaying the conclusion of a similarity until a sufficient level of evidence is collected in accordance with the principles of the invention. UUs and LUs are regularly stored in memory 160 for the purpose of retrieval, modification, and/or elimination. A collection of labeled and unlabeled uniquifiers provides a user profile. In a typical embodiment of the invention the user profile is also kept on the user device and hence provides a higher level of privacy protection than prior art solutions that rely on having user profiles in central databases.

As an example of a creation of the UUs the following description is provided without limiting the scope of the invention. For example, for sensors 110 that capture documents that the user access, vectors of weighted terms are created for each document. A document may include, but is not limited to, a web page, a document, a spreadsheet, a presentation, and the like. Vectors are then clustered using one or more of clustering processes. Each cluster typically contains a plurality of vectors and a cenetroid vector (CV) is then created for each cluster representing the vectors of the cluster. The CV of a cluster is an UU. In one embodiment an UU is further created by grouping of clusters and having a CV that is a more general UU. A threshold parameter is typically used for the determination of clusters. A further parameter may determine the maximum number of clusters to be generated, as well as a parameter for defining a minimum number of vectors within a cluster before such a cluster is determined to be usable for the generation of a CV representing it as an UU. It is noted that while vectors are discussed in the description of the invention that other forms of data representation such as graphs, semantic networks, etc., are possible without departing from the scope of the invention.

UUs are periodically updated as new sensory information is gathered by sensors 110 and features provided by feature extractor 120. Therefore, features may also be associated with a weight that causes them to decay over time. This ensures that as clustering is revisited, that older features have a lower weight than more recent features. However, in one embodiment of the invention, upon determination that certain new features have been created, a cluster that is at least similar to a cluster from the past and now a decaying cluster may revive such a decaying cluster. This may happen due to a periodic interest in a certain topic, for example “football”, which increases dramatically during the playing season and may significantly if not totally decrease during the off-season period. However, it is valuable to rapidly return to the knowledge level the system has about the user when return to the previous behavior pattern is identified.

In one embodiment of the invention a glossary of labels is made available. Each label represents a topic, such as “Travel”, and is described by a collection of terms represented using the vector space model or any other representation form, such as, without limitation, graphs, semantic nets, and others. These labels may be associated to an UU if an appropriate fit is found between the UU and the label description. In such a case the UU may become a sort of an LU, however, certain aspects pertaining to UUs may be kept for the now labeled UU. This process is internal to the user device that embodies architecture 100 and enables the user to manage certain UUs. Lacking a label a UU is not characterized and therefore cannot be activated or deactivated by a user. By providing a label, e.g., “football” the UU is manageable by the user that now understands the characteristic of the uniquifier.

Yet another type of uniquifier is the global uniquifier (GU). This kind of uniquifier is a synthetic uniquifier. The GU is created by assuming certain terms that are expected to be part of a GU. For example, and without limitation of the scope of GUs, a GU “football fan” may describe features that are expected to be found with a large number of football fans. The GU can then be used to check a UU of a user and make a more precise identification of the interests of such a person. In other words, the system supports checking the strength of each GU by comparing it to the current active UUs. Since every GU is related to the specific domain of interest, comparison between GU and UUs allows for checking the user's domain of interest. The GU enables an external entity to compare between internal UUs and certain characteristics deemed of interest by the external entity. It can create a GU and then request a query from the user device embodying architecture 100 to assess whether a match or similarity is found between the GU and one or more of the UUs of the user device. In another embodiment of the invention the external entity may provide several GUs that are constantly updated by the system. Then, the external entity may perform queries that use only the GUs in order to provide an answer.

Uniquifiers may be time variant, i.e., either change over time or be relevant at some times and irrelevant of have low-relevancy at other times. For example, a name of a person tends to be time invariant over very long periods of time, while a person's interest may change dramatically during the time of day, between the professional interests of a person and a particular hobby during off-job times. In accordance with an embodiment of the invention, the context of an operation of the user, is also determined. For example, if the system determines that the person is during work hours, possibly between 9 AM and 5 PM during workdays, then the primary concern for data is for information of a technical nature, while during off periods, that specific person is interested in early English poetry, and hence the information to be provided to that person should dramatically change during different periods of time. In another embodiment of the invention uniquifiers are further assigned an aging parameter that determines how fast an uniquifier should age. Some uniquifiers will have a high persistency while others shall be transient by nature. Hence at times certain uniquifiers may be active uniquifiers while others may be inactive uniquifiers and vice versa.

It is the responsibility of a service manager 170 to ensure that the correct context of the user is used. i.e., the active uniquifiers are those that are checked when queries to the system 100 are provided. While in one embodiment the determination of uniquifiers being active or not is binary, i.e., either active or inactive, it is within the scope of the invention that a degree of activeness is associated with an uniquifier. For example, as the workday comes to an end, it is possible that the degree of activeness of uniquifiers that are work associated goes down while leisure time uniquifiers become more active but not in a binary manner.

The collection of uniquifiers may be further used with respect to the context in which a user is at. For example, uniquifiers that generally relate to the user's work time may determine a user profile which is the ‘work time profile’ of that user. Such a profile may, for example, be independent of some of the user's uniquifiers, such as a specific hobby that is not related to the workday activities of the user. Other user profiles may also be possible. The architecture 100 is enabled to track the uniquifiers into such user profiles that are used in specific user context. That is, when the user is working the ‘work time profile’ is used, at least predominately, to determine responses to queries received by the system 100. The use of a temporal user profile allows to more accurately providing information to the user in context to the user's current activities of a user device.

The service manager 170 connected to a memory 160 is used to receive queries respective of the LUs, UUs and GUs and provide answers thereto. For example, a query may request to check whether a certain advertisement is suitable for a male in the age range of 21-28 that lives in New York, N.Y. The purpose of such a query is to assess the likelihood of a user to click on an advertisement, or otherwise determine if the user device will accept that advertisement for display to the user. The advertiser may further require an overall confidence level in excess of 80% on both checked parameters. The service manager 170 then checks the appropriate LUs for “age” and “location”, check the confidence level of each, and either accept or reject the offer to provide the advertisement. It should be appreciated that event that no information about the user is provided outside of the user device but still, an advertiser can have a good level of confidence that the advertisement reaches the right audience. In another example, the user initiates a search and receives in response a plurality of possible web pages which can be checked against the UUs and/or GUs of the user and present to the user only those links, or web pages, which match the active UUs of the user. All of this is performed without private information of the user leaving the user device. In one embodiment of the disclosed invention the more relevant links are marked, highlighted, emphasized or otherwise made more visibly noticeable by the user. It should be noted however, that while the system is targeted to provide a high-level of privacy to a user of the apparatus and the methods thereof, that there are other embodiments of the invention that may include partial or full implementation on a server. Such implementations do not depart from the spirit of the disclosed invention and are specifically included herein.

FIG. 2 depicts an exemplary and non-limiting schematic block diagram of a system 200 implementing the architecture 100. The system 200 comprises a processing unit 210, a memory 220, an input/output (I/O) interface 210, and plurality of sensors 240. The processing unit 210, the memory 220, the I/O interface 230 and the sensors 240 are connected to a bus 250 that enables the exchange of data between the various elements of the system 200. The sensors 240 are the physical sensors described hereinabove. Virtual sensors may be implemented in software, firmware, or combination thereof stored in the memory 220, and becoming operative when sequences of instructions are executed by the processing unit 210. Similarly, the feature extractor 120, the dispatch unit 130, the LU generator 140, the UU generator 150 and the service manager 170 (shown in FIG. 1), may be implemented in software, firmware or combination thereof in this system 200, and becoming operative when sequences of instructions are executed by the processing unit 210.

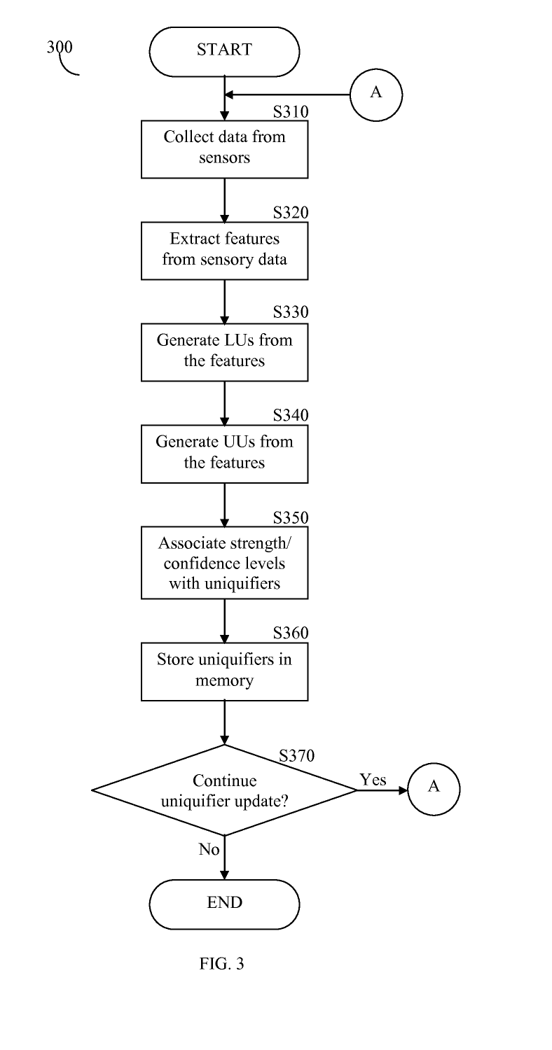

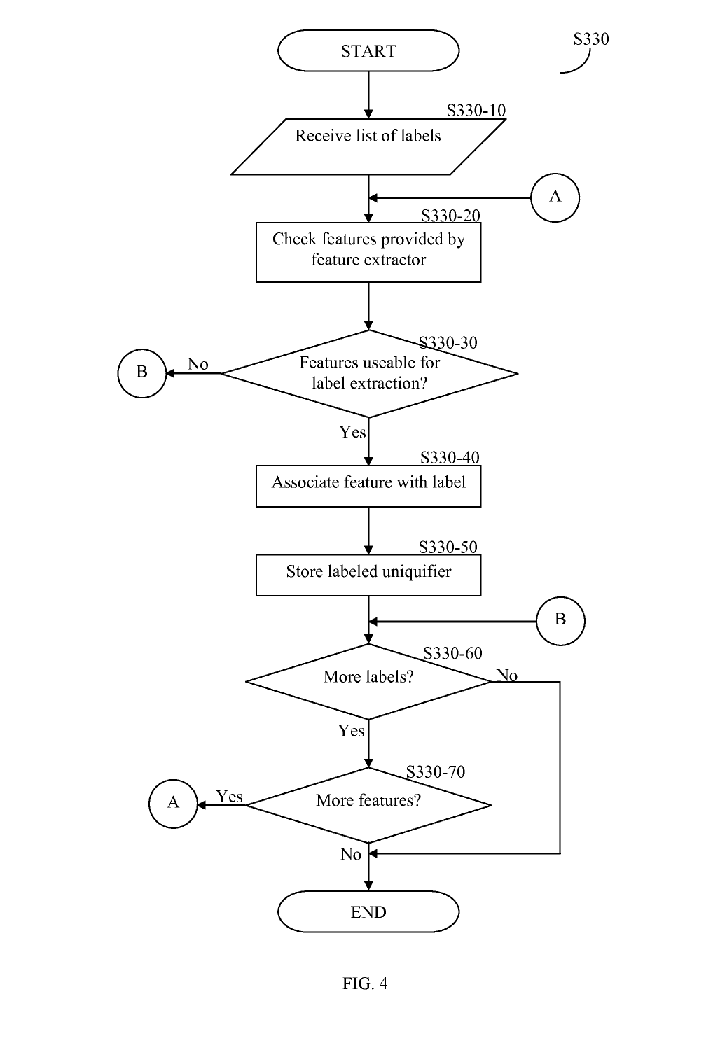

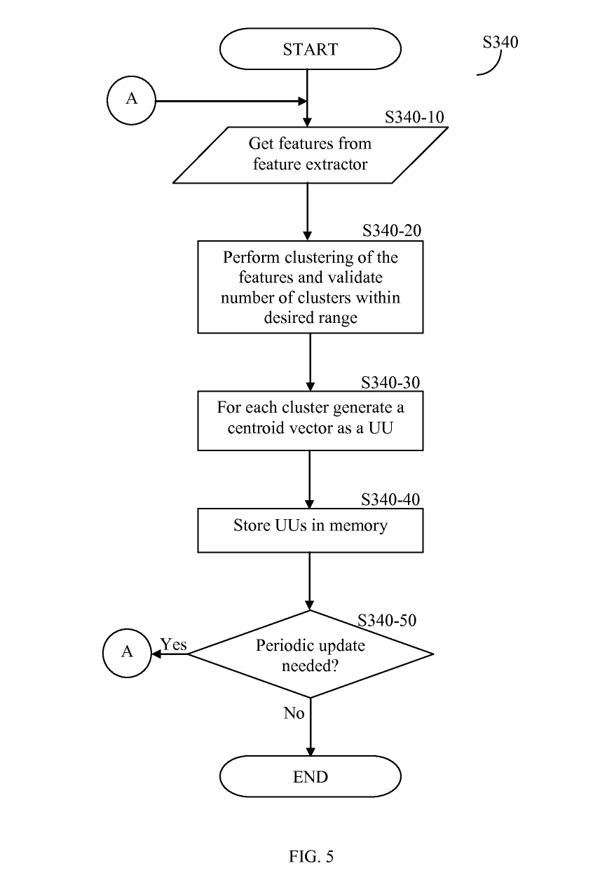

The operation of the architecture 100 and the corresponding system 200 may be further understood with respect to FIG. 3 where an exemplary and non-limiting flowchart 300, depicting the creation of a user profile in accordance with the principles of the invention, is presented. In S310 data is collected by the sensors 110. In S320 features are extracted from the data collected from the sensors 110 by the feature extractor 120. In S330 LUs are generated by the LU generator 140 responsive of at least some of the features extracted by the feature extractor 120 and dispatched by the dispatch unit 130. A more detailed description of S330 is provided with respect to FIG. 4 below. In S340 UUs are generated by the UU generator 150 responsive of at least some of the features extracted by the feature extractor 120 and dispatched by the dispatch unit 130. A more detailed description of S340 is provided with respect to FIG. 5 below. An exemplary but non-limiting description for creation of UUs was discussed hereinabove. In S350 confidence levels are associated with LUs and, potentially, strengths values with UUs. In S360 the uniquifiers are stored in memory. In S370 it is checked whether it is necessary to continue the uniquifiers update and/or generation and if so execution continues with S310; otherwise, execution terminates.

FIG. 4 depicts an exemplary and non-liming flowchart S330 illustrating the filling of content of the LUs. In S330-10 a list of labels that need to be matched with information is provided, for example to the LU generator 140. In S330-20 features provided by the feature extractor 120 are checked for information and/or clues for identification of a potential association with a label in the list. In S330-30 it is checked if the feature(s) suffice or otherwise useable for the purpose of activating a mechanism for extraction of label information and if so, execution continues with S330-40; otherwise, execution continues with S330-60.

In S330-40 the feature(s) that was found to match a label from the list of labels is associated with that label. As noted above, the association may require a specific handling on a per label basis. For example, the “age” label may be determined accurately assuming a response by a user when filling out a form concerning the user's age. However, this age may or may not be correct and hence other features may be used to further determine an age range that is derived from a plurality of features that enable a conclusion, at a specific level of confidence, of a possible age range of that user. That range may include the age provided by the user or, may be outside of that range. This could be used, for example, to prevent sending age restricted information to youngsters attempting to pose as adults eligible to receive such materials.

In S330-50 the LU is stored in s memory, for example, the memory 160. In S330-60 it is checked whether there are more labels that need to be matched with features and if so execution continues with S330-70; otherwise, execution terminates. In S330-70 it is checked whether there are more features that can be provided by the feature extractor 120, and if so execution continues with S330-20; otherwise execution terminates. It should be noted though that the system may periodically return to the determination of LUs as may be necessary and as new or more updated features are collected. It is further possible to have updates to the list of labels that may result in a need to generate and/or update the LUs.

An exemplary and non-limiting flowchart S340 that depicts the creation of UUs is shown in FIG. 5. In S340-10, features are received from the feature extractor 120. In S340-20 a clustering process of the features is initiated for the creation of a plurality of clusters of the features. In one embodiment of the invention the number of clusters is a predefined number. If more clusters than the predefined number are created, then a selection process may take place to select the most appropriate or fit clusters. In another embodiment, a threshold parameter for creating a cluster is provided that reduces the number of clusters the UU generator 150 attempts to create. In S340-30 a CV is generated for each cluster, the CV representing a cluster being an UU for the user of the user device. In S340-40 the UUs are stored in a memory, for example, the memory 160. In S340-50 it is checked if there is a need to periodically update the UUs, and if so execution continues, potentially after a present delay, with S340-10; otherwise, execution terminates. It should be noted that in a typical embodiment of the invention a periodic update of the UUs should take place as new features are collected by the feature extractor 120.

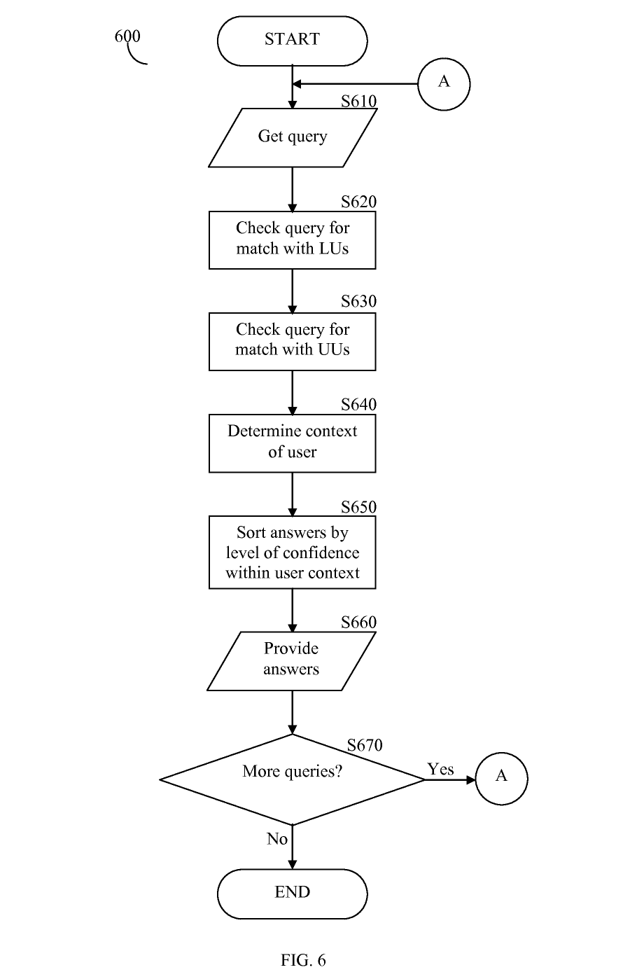

To further appreciate the operation of the architecture 100 and the corresponding system 200 further reference is made to FIG. 6 where an exemplary and non-limiting flowchart 400, that depicts the flow from a query to an answer in accordance with the principles of the invention. In S610 a query is received by the service manager 170. In S620 the query is checked for equality and/or match with LUs and is S630 it is checked for match with UUs and possibly GUs if defined. While for simplicity purposes this is described with respect to S620 and S630 it should be noted that, for example, a location of a user may be determined through both a LU and a UU, but also by only one type, either a LU or an UU, as the case may be. In S640 the context of the user may be determined. The context of the user may be helpful as the user may be looking for different things when the context is a work related context, versus a context of a holiday at another location of the world, and so on. By adding the context it is possible to better provide content to the user. For example, if the user watched a video clip about fishing the search for “salmon” may most likely be in the context of a fishing expedition rather than a cooking spree. Hence, by determining the context in which a user is in, the context related user profile may be used for the purpose of responding to queries. In S650 the answers received may be sorted by level of confidence, strength and/or context. In S660 the answers may be provided, or acted upon as may be necessary. In S670 it is checked whether additional queries are to be presented and if so execution continues with S610; otherwise, execution terminates. In one embodiment of the invention queries are received by the service manager 170 and stored in the memory 160. Periodically the query is revisited and checked against uniquifiers of the user stored in the memory 160 of the user device. Upon finding a match or an answer, the response is sent to the requesting entity. In one embodiment of the invention, after providing the answer the query is deleted from the memory 160, in another embodiment it remains in the memory and when applicable retrieved and checked for possible matches. This allows a delayed query process where answers are provided respective of the user using the user device asynchronously to the time the query was submitted to the system 100.

According to the invention a query may be provided from an external system to the system 200 of the user device. The uniquifiers need not be provided to the entity presenting the query thereby increasing the security and confidentiality level of the user's information without sacrificing the ability to provide accurate information. In fact, systems requiring information from a user to be transferred to a different system may often not be able to retrieve such information about the user as the user declines to provide such information external of the user system. The query received may be, for example and without limitation, a request to check if a specific web page would be of interest to the user using the user device. A vector of weighted terms may be created for that page, either by the querying entity or by the user device and then compared to the plurality of UUs stored in the memory of the user device. Then, if a match and/or equality is found it is determined that the page may be displayed to the user or otherwise, such is declined. Information about accepting or rejecting such web page may or may not be provided to the entity posing the request depending on confidentiality level setting made by the user of the user device.

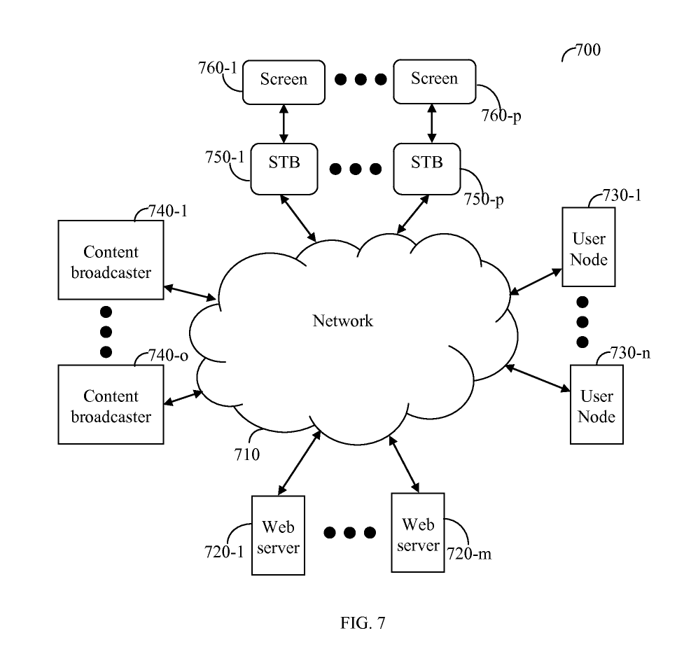

FIG. 7 shows an exemplary and non-limiting system 700 for uniquifier based personalized television (TV) provided in accordance with the principles of the invention. The personalized TV system 700 comprises a network 710 that may be a TV cable modem, a TV satellite network, a local area network (LAN), a wide area network (WAN), a metro area network (MAN), the Internet, the world-wide-web (WWW), the like, and any combination thereof. To the network 710 connected are one or more web servers 720-1 through 720-m which are enabled to provide web-based content to one or more user nodes 730-1 through 730-n that are also coupled to the network 710. At least one of the user nodes 730 (e.g., node 730-i; i=1, . . . , n) is further equipped with a system such as the system 100 that enables the collection of information about a user using respective sensors 110, and generation of respective uniquifiers of various types as has been discussed hereinabove in more detail. a user node 730-i has the ability to perform matches of content to the user based on the user's uniquifiers.

To the network 710 there are further connected one or more content broadcasters 740 that are enabled to provide television content over the network 710. That is, the broadcasters 740 are capable of delivering broadcast video content, including, without limitations, video-on-demand, and other services typical of such arrangements and that are well-known in the industry, over the network 710 to one or more of set-top boxes (STBs) 750-1 through 750-p. A STB 750-j (j=1, . . . , p) enables viewing of content from a content broadcaster 740 on a screen 760, for example a TV screen, connected to the STB 750-j. While a single screen is shown with respect to each STB 750 it should be understood that a plurality of screens may be coupled to an STB 750 where each may be displaying different content.

According to the principles of the invention a user node 730-i, that is enabled to generate uniquifiers respective of the user that may own or use STB 750-j. The uniquifiers of the user node 730-i may therefore be used to personalize the content presented to the user of STB 750-j. Accordingly, a user node 730-i is enabled to communicate with STB 750-j over the network 710. In one embodiment of the invention each of the user nodes 730-1 through 730-n, can be implemented as the system 200 described in greater detail above. In this embodiment, the processing unit of the user node is configured to generate personalized TV content lists based on at least the uniquifiers.

Being aware of the one or more of the content broadcasters 740-1 through 740-o, a user node 730-i is enabled to check the content of such content broadcasters, and based on the uniquifiers of the user node 730-i to determine the content that may be desirable for the user of user node 730-i. The user node 730-i can then communicate with its respective STB 750-j and cause one or more of the following: immediate display of content determined to be of interest to the user, display of the content determined to be of interest to the user as a picture-in-picture (PIP) the content determined to be of interest to the user, displaying a notification of content deemed to be of interest to the user and enabling the user of the STB 750-j to switch to viewing such content, displaying a content list that contains the programs determined to be of interest to the user, recording the content deemed to be of interest to the user, the like, and combinations thereof.

In another embodiment of the invention, the inputs received or otherwise generated by the user of the STB 750-j are deemed sensory inputs to the respective user node 730-i. That is, the sensory information is sensed by a sensor 110, designated to collect sensory information from the STB 750-j. This information is used to update the uniquifiers of the user of a user node 730-i, thereby ensuring a continuous update of the characteristics of the content promoted for display to the user. It should be noted that a user node 730 may include, but is not limited to, a PC, a PDA, a mobile device, a smart phone, and the like. The STB 750, in at least one embodiment of the invention, may be integrated as part of the user node 730, for example a smart phone operative as a user node as well as being enabled to operate as a STB for display of television broadcast on the screen of the cellular phone. Other integrations of a STB 750-j into a user node 730-i are further possible and specifically included herein.

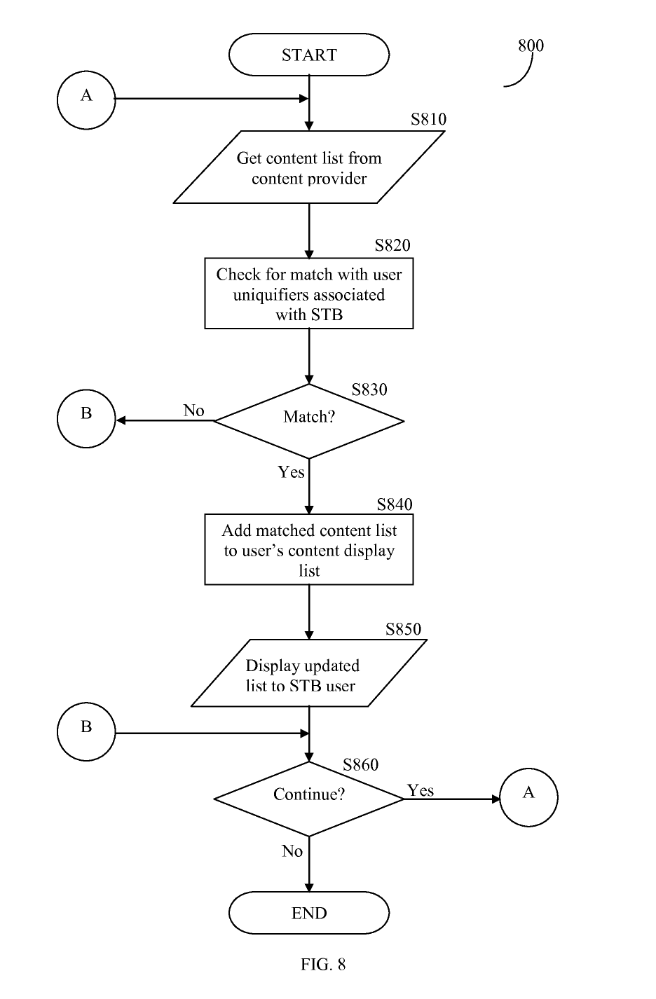

FIG. 8 depicts an exemplary and non-limiting flowchart 800 describing the process of personalization of TV content based on a user's uniquifiers. In S810 a user node 730-i, gets a content list from a content broadcaster 740. Such content list may contain detailed description about the content presented for viewed by the content broadcaster 740. In S820 the content list is matched or otherwise compared to one or more uniquifiers. This may be performed using the user node 730-i in accordance with the embodiments discussed hereinabove. For example, the matching and/or comparison is done without limitations, by means of queries to the system 200 of the user node 730-i that is equipped with the system for generating uniquifiers for the user of the user node 730-i.

In S830 it is checked whether a match was found, and if so execution continues with S840; otherwise, execution continues with S860. In S840 the content from the content list that has matched the user's uniquifiers is added, for example and without limitations, to a display list, the display list containing descriptions of content that was found to be by the system 100 of user node 730-i to be relevant to the user of the user node 730-i. In S850 the display list is provided to the STB, for example STB 750-j associated with user node 730-i, for display on the screen coupled to or associated with STB 750-j. In S860 it is checked whether it is necessary to continue with the method, and if so execution continues to S810; otherwise, execution terminates.

As noted above, other operations other than preparing a display list are possible, including, but not limited to, immediate display of content determined to be of interest to the user, display of the content determined to be of interest to the user as a picture-in-picture (PIP) the content determined to be of interest to the user, displaying a notification of content deemed to be of interest to the user and enabling the user of the STB 750-j to switch to viewing such content, recording the content deemed to be of interest to the user, the likes, and combinations thereof. One of ordinary skill in the art should appreciate that the teachings disclosed herein allow to maintain the user privacy as the user profile, or uniquifiers thereof, are not provided at any time to the content provider, for example, content broadcaster 740. Rather, determination of the content desirable to be viewed by a user is determined within the user's controlled environment.

According to another embodiment of the invention it is possible to determine the context of the user from the STB 750-j and/or the user node 730-i, thereby determining which profile, or otherwise which uniquifiers, should be used for the generation of the content list to be displayed for the user of the respective STB. For example, if the user is at a work context then work related information, such as, but without limitation, stock news is provided, while in the context of leisure, for example, a weekend, golf programming is provided.

While the disclosed invention is intended to protect to the maximum possible the user's privacy, another embodiment of the invention is possible. In such an embodiment the user profile, or uniquifiers thereof, are provided to a content broadcaster 740. The content broadcaster 740, responsive of receiving such information returns a content list that is tailored to the needs of the user based on the information provided. In another embodiment, a content broadcaster 740 may implement the processes performed by a user node 730 to provide personalized content based on the uniquifiers supplied to the broadcaster 740 by the user node 730. It should be appreciated that the user profile or uniquifiers thereof are provided to a resource outside the immediate control of the user, thus user privacy is compromised to at least some degree. However, such an arrangement would make it is possible to achieve a finer match, to determine a finer degree of match between the user's profile, or uniquifiers thereof, and the content provided by the content provider.

It should be noted that while various embodiments of the invention have been described with respect of content broadcasters, other content providers are specifically included herein, including without limitation, video-on-demand (VOD) suppliers.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

The principles of the invention may be implemented as any combination of hardware, firmware and software. Moreover, the software is preferably implemented as an application program tangibly embodied on a program storage unit, a computer readable medium or a machine readable medium. One of ordinary skilled in the art would recognize that a “machine readable medium” or “computer readable medium” is a medium capable of storing data and can be in a form of a digital circuit, an analogy circuit, magnetic media, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

1. A method for personalization of television content, comprising:
determining if input information respective of the television content matches one or more uniquifiers of a user of a set-top box (STB), wherein a uniquifier characterizes a user of a user node that is associated with the STB;
updating a personalized content list if the match is determined to exist; and
displaying the personalized content list on a television screen coupled to the STB.

2. The method of claim 1, wherein the personalized content list includes at least one of a list of television programs deemed to be of interest to the user and television programs deemed to be of interest to the user.

3. The method of claim 1, wherein the one or more uniquifiers are generated by:
collecting data respective of the user by using a plurality of sensors enabled to sense the user node;
generating one or more uniquifiers from the data;
evaluating periodically the one or more uniquifiers; and
storing the one or more uniquifiers in a memory of the user node; wherein that the uniquifiers enable to provide an answer responsive to receiving a query by the user device without a requirement to provide the uniquifiers externally of the user device, the answer being based on at least a uniquifier of the one or more uniquifiers stored in the memory.

4. The method of claim 3, wherein the uniquifiers are at least one of labeled uniquifiers, unlabeled uniquifiers, and global uniquifiers.

5. The method of claim 3, further comprises:
sensing information respective of the use of the STB.

6. The method of claim 1, further comprises:
identifying a context of the user respective of at least one of the user node and the STB.

7. The method of claim 1, further comprises:
providing the one or more uniquifiers to a provider of the television content for determination of the personalized content list.

8. The method of claim 2, wherein displaying the personalized content list includes at least one of immediate display of contents of the personalized content list, display of contents of the personalized content list as a picture-in-picture (PIP), display of a notification respective of the personalized content list, and recording contents of the personalized content list.

9. The method of claim 1, wherein the user node is at least one of a personal computer, a personal digital assistant, a mobile device, and a smart phone.

10. The method of claim 1, wherein the STB is integrated into one of a television, a personal computer (PC), a personal digital assistant (PDA), a mobile device, and a smart phone.

11. The method of claim 1, is executed by computer executable code stored in computer readable medium.

12. A user node for personalization of television content, comprising:
an interface to a network, wherein the network is connected to one or more web servers, one or more television content providers, and at least one STB associated with the user node;
one or more sensors adapted to collect data respective of the user using the user node;
a processing unit for generating a plurality of uniquifiers based on the user usage of the user node and periodically generating a personalized content list for the at least one STB responsive of the plurality of uniquifiers and input information respective of television content; wherein the uniquifiers characterize the user.

13. The user node of claim 12, further comprised:
a sensor associated with the STB, the sensor is adapted to collect data respective of the user using the STB.

14. The apparatus of claim 12, wherein the uniquifiers are at least one of labeled uniquifiers, unlabeled uniquifiers, and global uniquifiers.

15. The user node of claim 12, wherein the processing unit further identifies a context of the user respective of at least one of the user node and the STB.

16. The user node of claim 12, wherein the processing unit further provides the uniquifiers to a provider of television content for determination of the personalized content list.

17. The user node of claim 16, wherein the personalized content list comprises at least one of a list of television programs deemed to be of interest to the user and television programs deemed to be of interest to the user; wherein displaying the personalized content list includes at least one of immediate display of contents of the personalized content list, display of contents of the personalized content list as a picture-in-picture (PIP), display of a notification respective of the personalized content list, and recording contents of the personalized content list.

18. The user node of claim 12, wherein the user node is integrated in at least one of a personal computer (PC), a personal digital assistant (PDA), a mobile device, and a smart phone.

19. The user node of claim 12, wherein the STB is integrated into one of a television set, a personal computer (PC), a personal digital assistant (PDA), a mobile device, and a smart phone.

20. A system for personalization of television content comprising:
a network;
one or more web content servers connected to the network;
one or more television content providers connected to the network;
one or more user nodes coupled to the network, at least a first user node that generates uniquifiers respective of the user of the first user node and further generates a personalized content list respective of the uniquifiers; and
one or more set-top boxes (STBs) coupled to the network, wherein at least a first STB is associated with the first user node, the at least first STB receives the personalized content list.
